(19) United States
(12) Patent Application Publication
(10) Pub. No.: US 2013/0110967 A1
(43) Pub. Date: May 2, 2013

(54) INFORMATION SYSTEM AND METHOD FOR MANAGING DATA IN INFORMATION SYSTEM

(71) Applicants: Atsushi Ueoka, Tokyo (JP); Takaki Nakamura, Tokyo (JP); Takayuki Fukatani, Tokyo (JP); Keiichi Matsuzawa, Tokyo (JP); Jun Nemoto, Tokyo (JP); Atsushi Sutoh, Tokyo (JP); Masaaki Iwasaki, Tokyo (JP)

(72) Inventors: Atsushi Ueoka, Tokyo (JP); Takaki Nakamura, Tokyo (JP); Takayuki Fukatani, Tokyo (JP); Keiichi Matsuzawa, Tokyo (JP); Jun Nemoto, Tokyo (JP); Atsushi Sutoh, Tokyo (JP); Masaaki Iwasaki, Tokyo (JP)

(73) Assignee: HITACHI, LTD., Tokyo (JP)

(21) Appl. No.: 13/319,883

(22) PCT Filed: Nov. 1, 2011
(86) PCT No.: PCT/JP2011/006105

§ 371 Date: Nov. 10, 2011

(51) Int. Cl. G06F 15/167

(52) U.S. Cl. 709/214

(57) ABSTRACT

The prior art information system could not migrate a file in a file sharing system provided by a file storage to a plurality of cloud storages having different forms of connection and different properties, and therefore, could not manage the files via a single Stub information. The present invention provides a data mover program in a file storage to select one or more migration destination cloud storages based on a migration policy, a connection information table of cloud storages and a property information table of cloud storages. Then, a Stub information of the migrated file is created, and an identification information of the file in the cloud storage is stored in a file information table. When access occurs from a client to a file storage, the data mover program downloads a file from the cloud storage stored in the file information table corresponding to the Stub information and provides the file to the client.

### TECHNICAL FIELD

The present invention provides an information system for migrating data stored in a file storage to a cloud storage, and a method for managing data in a file storage for realizing a configuration in which the file storage utilizes a plurality of cloud storages.

### BACKGROUND ART

File storages such as a NAS (Network Attached Storage) for providing a file sharing system that can be accessed from a plurality of computers via a network using NFS (Network File System) protocol or CIFS (Common Internet File System) protocol are provided. The amount of data stored in such file storages are increasing year by year, and there are demands for a more efficient system for operating the same.

Thus, a storage tiering function is provided for changing the storage destination storages according to the frequency of use of the files. One example of such tiered data storage function is disclosed in which the files no longer accessed in the file storage are archived to external storages, and Stub information storing file path names including the identification information of files in the archive destination storages are created in the file storage (patent literature 1). When a user of the file storage accesses a file corresponding to the Stub information, the system refers to the file path name in the external storage stored in the Stub information to download the file to the file storage and provides the same to the user.

### CITATION LIST

### Patent Literature

PTL 1: Japanese Patent Application Laid-Open Publication No. 2010-009573 (US Patent Application Publication No. US 2009/0319736)

### SUMMARY OF INVENTION

### Technical Problem

According to the above-described prior art, a single file is archived to a single external storage via the Stub information. Therefore, if a failure occurs in the external storage, it becomes impossible to download files referring to the Stub information. Further, when concentrated accesses occur to the archive destination external storage, the performance of the file storage is deteriorated significantly and the response time is elongated. In order to cope with this problem, an arrangement is considered in which a plurality of external storages of the same type are prepared and the same files are archived to the plurality of external storages.

According to the present configuration, since only external storages of the same type are used, not only the forms of connection such as the access protocol and authentication information of the external storages but also the identification information and content ID of the archived files can be made common among the external storages. Therefore, if the used external storages are restricted to identical types of storages, the prior art technology of storing a single identification information in a single Stub information can be applied to using the same file identification information among the plurality of external storages to correspond to load dispersion and system failure.

On the other hand, it is possible to adopt an arrangement for using a storage provided by a cloud provider (hereinafter referred to as cloud storage) as the destination for archiving the files in the file storage. Storages provided as cloud storages adopt different types and different models of storages such as file storages and CAS (Content Addressed Storages) among providers providing the storage service. Due to such difference, the forms and values of identification information of the same file differ among respective cloud storages. Further, forms of connection to the cloud storages, such as the access protocol and the authentication information, and the reliability or operation costs of the storages differ among cloud storages.

There are private cloud storages operated by the company operating the file storages and restricted to use within the company and public cloud storages having no usage limitations. In general, private cloud storages store secret information within the company and public cloud storages store information that does not cause any problem when opened to public.

According to the prior art, since a single file identification information can be stored in a single Stub information, if values and forms of file identification information differ among archive destination storages, different Stub information must be created for each of the external storages. The user of the file storage must refer to multiple Stub information per a single file, so that the user is required to select one Stub information, according to which the usability of the system is deteriorated. The teachings of the prior art does not enable to compose a multiplexed archive system using a plurality of cloud storages having different forms of connection, and to cope with failures. Further, it is not possible according to the prior art teachings to perform load distribution and tier control considering the properties of the respective cloud storages.

### Solution to Problem

In order to solve the problems of the prior art mentioned above, the present invention provides a data mover program in a file storage that selects one or more cloud storages as migration destination based on a migration policy, a connection information table of cloud storages and a property information table of cloud storages. Then, a Stub information of the migrated files is created, and an identification information of the file in the cloud storages is stored in a file information table. When a client accesses the file storage, the data mover program downloads a file from the cloud storage stored in the file information table corresponding to the Stub information, and provides the same to the client.

More specifically, the present invention provides an information system (file storage) coupled to a plurality of storage devices (cloud storages), the information system comprising a control unit, a memory unit and a storage device unit, wherein the control unit creates a file sharing information for sharing the file at the time of a first data migration of a file in the storage device unit to a first storage device, thereby mapping the file sharing information to the file being subjected to data migration, and after a second data migration for migrating the file in the storage device unit to a second storage device that differs from the first storage device, the control unit maps the file being subjected to data migration to the file sharing information.

Furthermore, tables for managing connection information and property information of the cloud storages and providers of the storage service are created in the file storage, so as to enable multiple identification information to be stored in the Stub information. The file storage can migrate files to a plurality of cloud storages based on the connection information, and the identification information provided in the respective cloud storages can be managed via a single Stub information.

### Advantageous Effects of Invention

According to the present information system using a plurality of cloud storages and the method for managing data in the information system, the files stored in the file storages are migrated to a plurality of cloud storages, and the identification information of the file in the respective cloud storages are managed via a single Stub information. Further, the forms of connection that differ among cloud storages are managed via a connection information table, and communication with the cloud storages are performed based on the information. Furthermore, migration destination cloud storages are selected based on the properties of the cloud storages. According to the above arrangement, even if a failure occurs to a cloud storage in a system using a plurality of cloud storages in heterogeneous environment, it becomes possible to obtain files from a different cloud storage. Further, it becomes possible to perform load distribution and tier control among cloud storages. As a result, the usability and operability of the system is enhanced.

### BRIEF DESCRIPTION OF DRAWINGS

FIG. 1 is a view showing one example of a configuration of a system using a plurality of cloud storages to which a method for managing data according to the present invention is applied.

FIG. 2 is a view showing one example of the arrangement of a file storage client.

FIG. 3 is a view showing one example of a file storage arrangement.

FIG. 4 is a view showing one example of arrangement of a cloud storage according to a first embodiment of the present invention.

FIG. 5 is a view showing one example of the relationship between a Stub information in a file storage and files in cloud storages.

FIG. 6 shows an example of a migration policy.

FIG. 7 is a view showing one example of a status information table according to embodiment 1.

FIG. 8 is a view showing one example of a connection information table.

FIG. 9 is a view showing one example of a property information table.

FIG. 10 is a view showing one example of a file information table.

FIG. 11 is a flowchart showing a file migration process for migrating a file to a cloud storage via the data mover program according to embodiment 1.

FIG. 12 is a flowchart showing a process for downloading a file from a cloud storage via the data mover program according to embodiment 1.

FIG. 13 is a flowchart showing a retry process for migrating files via the data mover program according to embodiment 1.

FIG. 14 is a view showing one example of the arrangement of a cloud storage according to embodiment 2.

FIG. 15 shows an example of arrangement of a status information table according to embodiment 2.

FIG. 16 is a flowchart showing a file migration process for migrating files to the cloud storage via the data mover program according to embodiment 2.

FIG. 17 is a flowchart showing the replication process for replicating files via the data mover program according to the second embodiment.

### DESCRIPTION OF EMBODIMENTS

Now, the preferred embodiments of the present invention will be described with reference to the drawings. A storage system is described as the subject according to the present description of embodiments of the present invention, but the present invention is not limited to storage system, and can be applied for example to information processing systems such as servers.

### Embodiment 1

One example of a configuration in which a file storage connects to a plurality of cloud storages is a configuration in which the file storage is directly connected to all the cloud storages. A first embodiment of the present invention is based on this configuration.

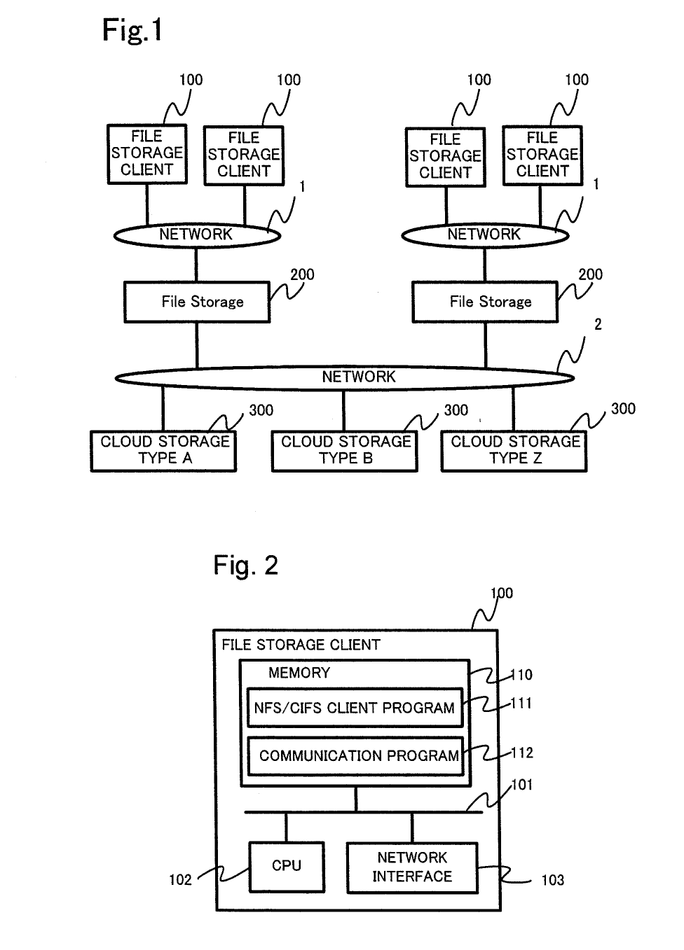

The first embodiment of the present invention will be described with reference to FIGS. 1 through 13. FIG. 1 illustrates one example of a system configuration to which the present invention is applied. As illustrated, the system according to the present embodiment is composed of at least one file storage 200, at least one file storage client 100 using the file storage 200 via a network 1, and at least two or more cloud storages 300 capable of being connected via a network 2 to the file storage 200.

FIG. 2 is a view illustrating one example of a configuration of a file storage client 100. As shown, the file storage client 100 (hereinafter abbreviated as client 100) comprises a CPU 102, a network interface 103 for connection to a network 1, a memory 110, and an internal bus 101 to which the CPU 102, the network interface 103 and the memory 110 are connected.

The memory 110 stores an NFS/CIFS client program 111 for accessing a file sharing system provided by the file storage 200 via NFS or CIFS protocol, and a communication program 112 for enabling communication via a communication protocol of the network 1 via a network interface 103. The CPU 102 executes these programs. Although not shown, the memory 110 also has an operating system (OS) stored therein.

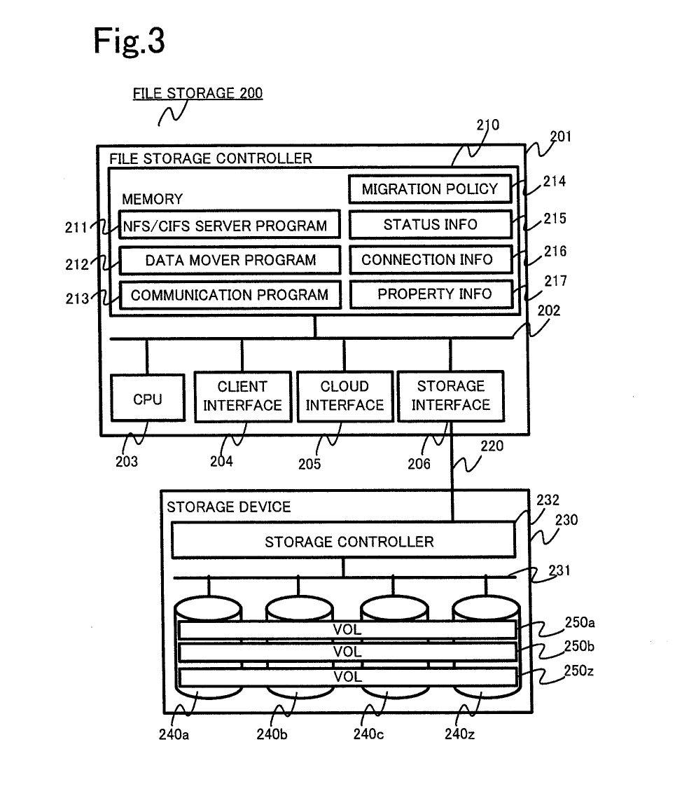

FIG. 3 is a view showing one example of a configuration of the file storage 200. As shown in FIG. 3, the file storage 200 is composed of a file storage controller 201 and a storage device 230. The file storage controller 201 includes a CPU 203, a client interface 204 connected to the network 1, a cloud interface 205 connected to the network 2, a storage interface 206 connected to the storage device 230, a memory 210, and an internal bus 202 connecting the aforementioned components.

The memory 210 stores therein an NFS/CIFS server program 211 for controlling access from a client 100 via NFS/CIFS protocol to the file sharing system provided by the file storage 200, a data mover program 212 executing the process of archiving files to the cloud storage 300 or the downloading of files archived in the cloud storage to the file storage 200, and a communication program 213 for performing communication processes via the client interface 204 or the cloud interface 205 with the client 100 or the cloud storage 300. The CPU 203 executes these programs.

Further, the memory 210 stores a migration policy 214 for entering policies for selecting the file to be migrated to a cloud storage 300 or the migration destination cloud storage 300 via the data mover program 212, a status information table 215 storing the state of the cloud storage 300 to which the file storage 200 can be connected, a connection information table 216 storing the form of connection to the respective cloud storages 300, and a property information table 217 storing the properties of the respective cloud storages 300.

The storage device 230 constituting the file storage 200 is composed of hard disks 240a, 240b to 240z constituting one or more logical volumes 250a, 250b to 250z provided as a file sharing system by the file storage controller 201, a storage controller 232 controlling the access from the file storage controller 201 to these logical volumes, and an internal bus 231 connecting the aforementioned components. The file storage controller 201 is connected via a connecting line 220 connected to the storage interface 206 to the storage controller 232. The connecting line 220 can be, for example, a FC (Fiber Channel) network.

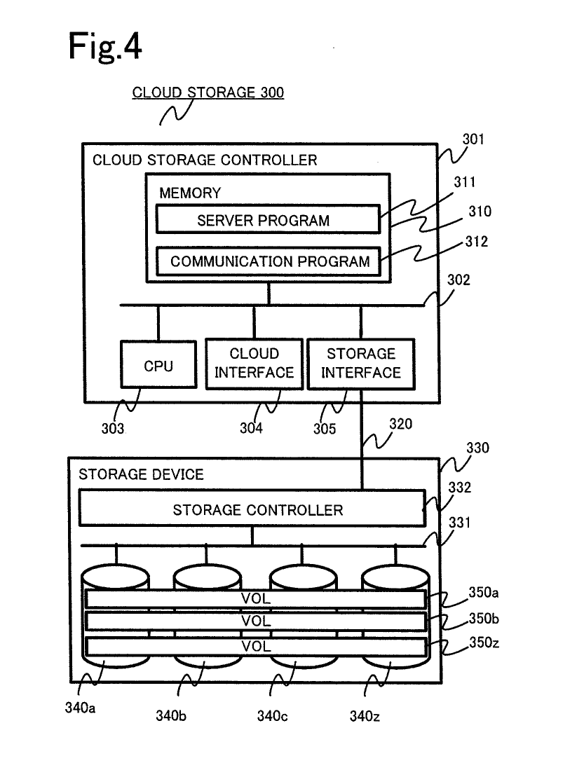

FIG. 4 illustrates an example of the configuration of a cloud storage 300 according to the present embodiment. As shown in FIG. 4, the cloud storage 300 is composed of a cloud storage controller 301 and a storage device 330. The cloud storage controller 301 is composed of a CPU 303, a cloud interface 304 connected to the network 2, a storage interface 305 connected to the storage device 330, a memory 310, and an internal bus 302 connecting the aforementioned components. The memory 310 stores a server program 311 implementing access control to the cloud storages 300, and a communication program 312 for implementing communication processing via the network 2. These programs are executed via the CPU 303.

The storage device 330 constituting the cloud storage 300 is composed of at least one or more hard disks 340a to 340z having at least one or more logical volumes 350a to 350z storing files being migrated from the file storage 200 via the cloud storage controller 301, and a storage controller 332 for controlling the access to logical volumes 350a to 350z from the cloud storage controller 301, and an internal bus 231 connecting the aforementioned components. The cloud storage controller 301 is connected via a connecting line 320 connected to the storage interface 305 to the storage controller 332. The aforementioned connecting line 320 can be, for example, a FC (Fiber Channel) network.

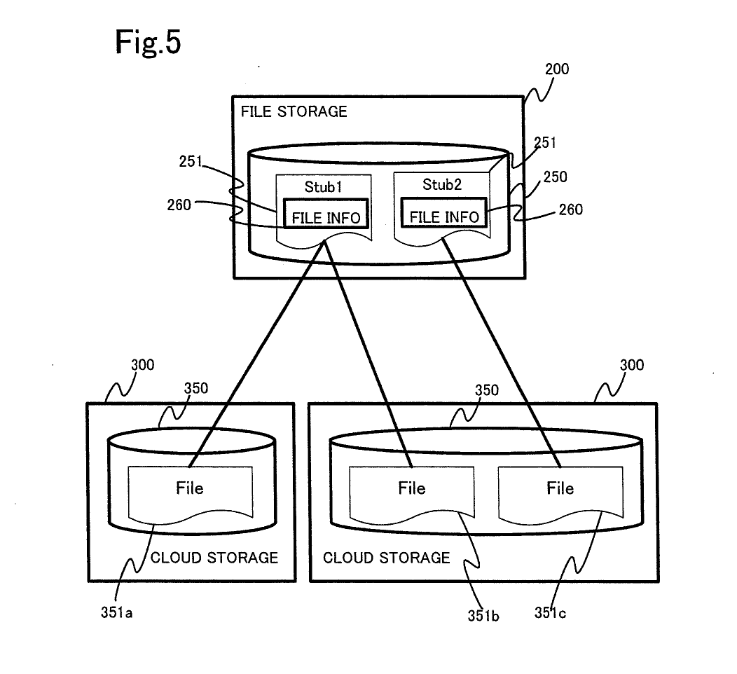

FIG. 5 is a view showing a corresponding relationship between a Stub information in the file sharing system of the file storage 200 and the file in the logical volume of the cloud storage 300. As shown in FIG. 5, the file storage 200 provides a file sharing system 250. The file sharing system 250 is created by using any of or all of logical volumes 250a through 250z.

The file sharing system 250 stores a Stub information 251, and the Stub information 251 has a file information table 260 storing a cloud storage 300 in which the files denoted by the Stub information are stored and identification information of the files within the cloud storage 300. The cloud storage 300 stores files 351a, 351b and 351c within a storage area 350. The files 351a and 351b are mapped to Stub information 1 and the file 351c is mapped to Stub information 2.

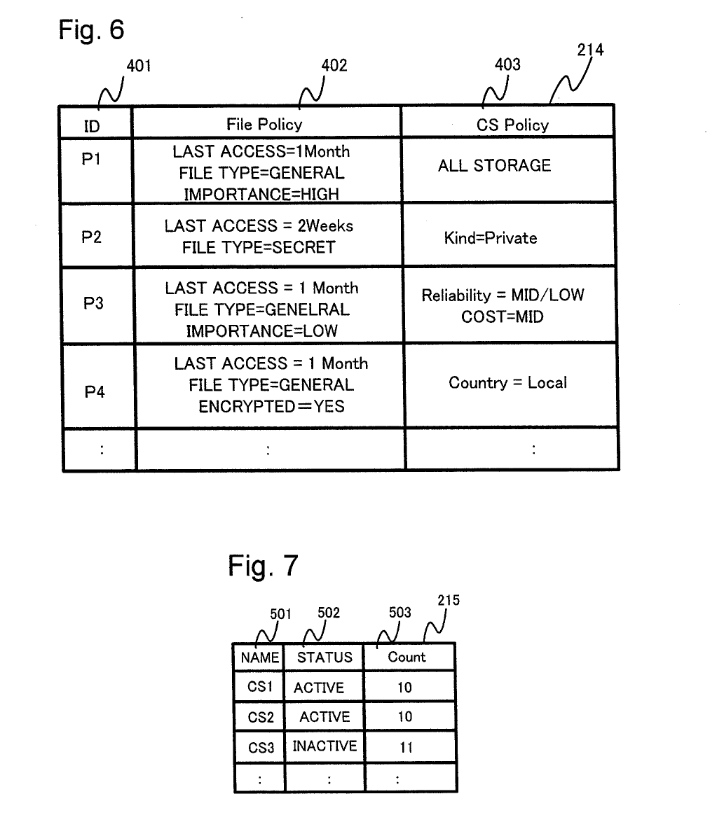

FIG. 6 is a view showing one example of the migration policy 214. The migration policy 214 includes a policy ID field 401 for storing IDs for identifying the stored policies, a file policy field 402 for storing conditions for selecting the files to be migrated, and a cloud storage (CS) policy field 403 for storing conditions for selecting the cloud storage being the migration destination of the files selected via the conditions of the file policy field 402.

For example, it can be recognized from the entry whose value of the policy ID field 401 is “P1” that files that have not been accessed from the user for a month “LAST ACCESS=1 Month”, which are general files “FILE TYPE=GENERAL” and have high importance “IMPORTANCE=HIGH” can be migrated to all cloud storages “ALL STORAGE”.

Further, it can be recognized from the entry whose value of the policy ID field 401 is “P2” that files that have not been accessed from the user for two weeks “LAST ACCESS=2 Weeks” and storing secret information “FILE TYPE=SECRET” are migrated to a private cloud storage “Kind=Private”.

Furthermore, it can be recognized from the entry whose value of the policy ID field 401 is “P3” that files that have not been accessed from the user for a month “LAST ACCESS=1 Month”, which are general files “FILE TYPE=GENERAL” and have low importance “IMPORTANCE=LOW” are migrated to cloud storages having middle to low reliability “Reliability=MID/LOW” and are inexpensive “COST=LOW”.

Further, it can be recognized from the entry whose value of the policy ID field 401 is “P4” that files that have not been accessed from the user for a month “LAST ACCESS =1 Month”, which are general files “FILE TYPE=GENERAL” and encrypted “ENCRYPTED=YES” can be migrated to domestic cloud storages “Country=Local”.

FIG. 7 is a view showing one example of a status information table 215 storing the status of the cloud storage 300. The status information table 215 has a CS name field 501 storing a name for identifying the cloud storage 300, a CS status field 502 storing the status of the cloud storage 300 identified by the name in the CS name field 501, and a download count field 503 for storing the number of downloads of files from the cloud storage 300 identified by the name in the CS name field 501. For example, it can be recognized that according to the entry whose value of the CS name field 501 is “CS1”, the cloud storage “CS1” is active “ACTIVE” and that there were 10 downloads therefrom.

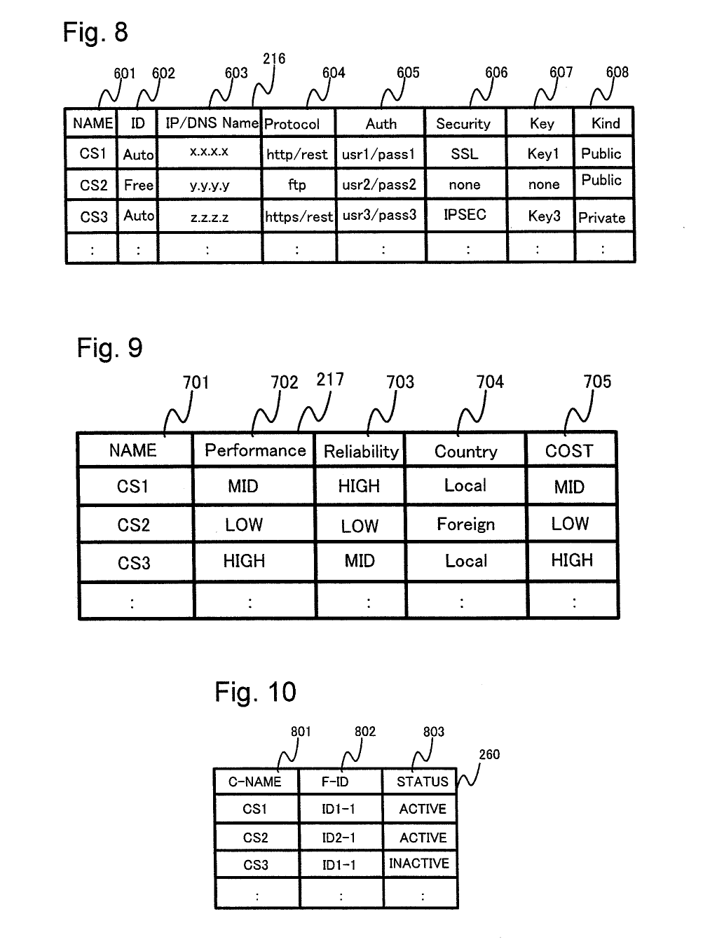

FIG. 8 is a view showing one example of a connection information table 216 storing information for connecting to the cloud storage. The connection information table 216 has a CS name field 601 storing a name for identifying the cloud storage 300, a setup ID field 602 showing whether identification information of the stored file is set automatically or set from the exterior, an IP address/DNS name field 603 storing the IP address of the cloud storage 300, a protocol field 604 storing the protocol supported by the cloud storage 300, and an authentication information field 605 storing the authentication information for connecting to the cloud storage 300. Further, the connection information table 216 has an encrypted communication system field 606 storing the encrypted communication system supported by the cloud storage 300, a key information field 607 storing the information of a key used for encrypting the encrypted communication system field 606, and a usage information field 608 storing information indicating whether the cloud storage 300 is a private cloud storage usable only within the company operating the file storage 200 or a public cloud storage without any usage limitations.

For example, it can be recognized from the entry whose value of the CS name field 601 is “CS1” that the cloud storage “CS1” is a public cloud storage that sets identification information of stored files automatically “Auto”, has an IP address of “x.x.x.x”, an access protocol of “http/rest” and an authentication information of “usr1/pass1”, performs encrypted communication using an SSL (Secure Socket Layer) and uses “key1” as the key for SSL communication.

Further, it can be recognized from the entry whose value of the CS name field 601 is “CS2” that the cloud storage “CS2” is a public cloud storage that sets identification information of stored files from an exterior “Free”, has an IP address of “y.y.y.y”, an access protocol of “ftp” and an authentication information of “usr2/pass2”, and that it does not support encrypted communication.

It can be recognized from the entry whose value of the CS name field 601 is “CS3” that the cloud storage “CS3” is a private cloud storage that sets identification information of stored files automatically “Auto”, has an IP address of “z.z.z.z”, an access protocol of “https/rest” and an authentication information of “usr3/pass3”, performs encrypted communication using IPSec and uses “key3” as the key for IPSec communication.

FIG. 9 is one example of a property information table 217 storing the properties of the cloud storage 300. In the example of FIG. 9, the property information table 217 comprises a CS name field 701 storing names for identifying the cloud storage 300, a performance field 702 storing the performance of the cloud storage 300, a reliability field 703 for storing the reliability of the cloud storage 300, an installation location field 704 indicating whether the installation location of the cloud storage 300 is domestic or foreign, and a unit cost field 705 storing whether the bit unit cost for storing data in the cloud storage 300 is high or low.

For example, it can be recognized from the entry whose value of the CS name field 701 is “CS1” that the cloud storage “CS1” has a middle class performance “MID” and a high reliability “HIGH”, is located within the country “Local” and has a middle-class bit unit cost “MID”. Further, it can be recognized from the entry whose value of the CS name field 701 is “CS2” that the cloud storage “CS2” has a low class performance “LOW” and a low reliability “LOW”, is located outside the country “Foreign” and has a low bit unit cost “LOW”.

The respective fields constituting the property information table 217 shown in FIG. 9 are mere examples and are not restricted thereto, and other cloud storage properties can be stored thereto. For example, actual numerical values can be stored in the performance field 702 and the unit cost field 705 instead of relative values. Further, actual country names can be stored in the installation location field 704. A new field for storing whether the country allows to export encryption technology or not can be provided. Other fields for storing the distance from the file storage or the latency indicating the communication delay within the network can also be provided.

FIG. 10 shows an example of a file information table 260 showing the corresponding relationship between the files indicated by the Stub information stored in Stub information 251 and 252 and the actual location of the file. The file information table 260 includes a CS name field 801 storing the name for identifying the cloud storage storing the file denoted by the Stub information 251, a file ID field 802 storing the identification information of the file denoted by the Stub information 251 in the cloud storage shown in the CS name field 801, and a CS access availability status field 803 for storing the status of access availability to the file identified in the file ID field 802.

It can be recognized from the example of FIG. 10 that the files corresponding to the Stub information are stored having identification information “ID1-1”, “ID2-1” and “ID1-1” in cloud storages named “CS1”, “CS2” and “CS3”, and that the files can be accessed from cloud storages “CS1” and “CS2” (“ACTIVE”) while the file cannot be accessed from cloud storage “CS3” (“INACTIVE”). Further, although not shown in FIG. 10, if the value stored in the CS access availability status field 803 is “ERROR”, it means that migration of a file to the cloud storage denoted by the CS name field 801 has failed.

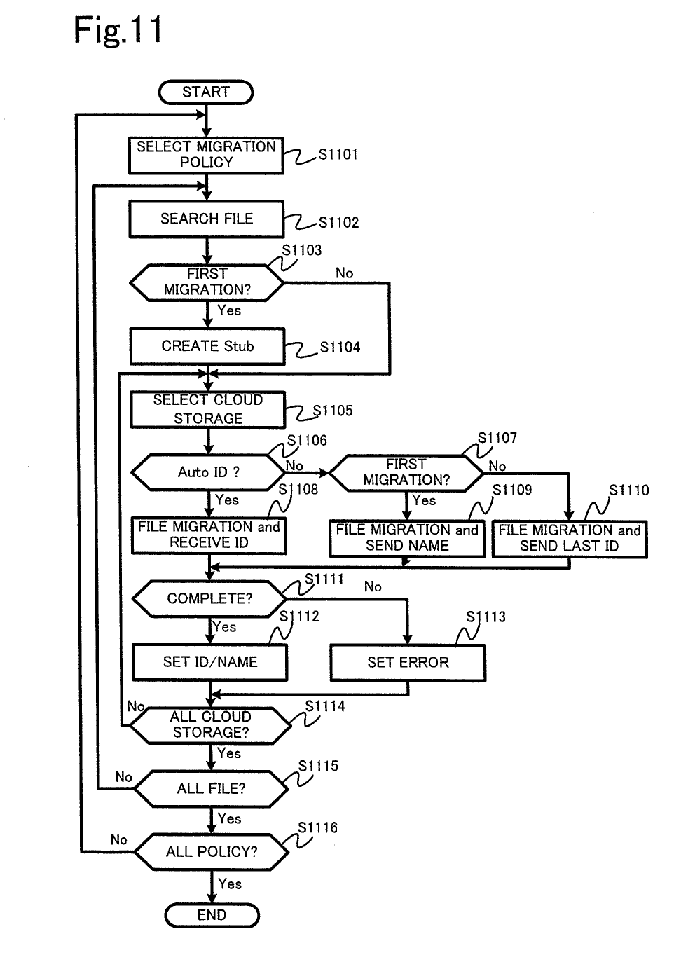

Next, with reference to FIGS. 11 to 13, a process for migrating files from the file storage 200 to the cloud storage 300 and a process for downloading the files from the cloud storage 300 to the file storage 200 when access occurs from the client 100 to the Stub information 251 according to the present embodiment will be described.

FIG. 11 is a flowchart illustrating the process of the data mover program 212 migrating a file in the file storage 200 to the cloud storage 300 according to the migration policy 214. At first, in S1101, the data mover program 212 acquires one entry of the migration policy 214. Then, in S1102, the data mover program 212 searches and selects from the file sharing system a file that matches the conditions in the file policy field 402 of the migration policy 214 acquired in S1101. If the file selected in S1102 is migrated for the first time, the data mover program 212 creates a Stub information for that file in the file sharing system (S1103, S1104).

Next, in S1105, the data mover program 212 selects a cloud storage that matches the conditions in the cloud storage (CS) policy field 403 of the migration policy 214 acquired in S1101 from the contents of the connection information table 216 or the property information table 217. For example, if the data mover program 212 selects an entry having value “P1” stored in the policy ID field 401, all the cloud storages 300 will be the select target since the value stored in the file policy field 402 is “ALL STORAGE”, and one cloud storage is selected therefrom.

Further, if the data mover program 212 selects an entry having value “P2” stored in the policy ID field 401 in S1101, a private cloud storage will be the select target since the value stored in the file policy field 402 is “Kind =Private”, so that only the cloud storage “CS3” having the value “Private” stored in the usage information field 608 of the connection information table 216 will be the migration destination.

If the data mover program 212 selects an entry having value “P3” stored in the policy ID field 401 in S1101, a cloud storage having middle or low level of reliability “Reliability=MID/LOW” and having a low cost “COST=LOW” will be the select target, so that only the cloud storage “CS2” having value “Low” stored in the reliability field 703 and value “LOW” stored in the unit cost field 705 will be the migration destination.

Next, in S1106, the data mover program 212 refers to the setup ID field 602 of the entry in the connection information table 216 corresponding to the cloud storage 300 selected in S1105, and confirms whether the cloud storage 300 selected in S1105 automatically sets up the identification information of the stored file or not. If the information is set up automatically, in other words, if the value in the setup ID field 602 is “Auto”, in S1108, the data mover program 212 migrates the file selected in S1102 to the cloud storage 300 selected in S1105, and acquires the identification information of the migrated file from the cloud storage 300. At this time, the data mover program 212 refers to the entry of the connection information table 216 corresponding to the migration destination cloud storage 300, and connects to the cloud storage to send the file.

If as a result of confirming in S1106 the cloud storage does not perform automatic setup, in other words, if the value in the setup ID field 602 is “Free” (S1106 “No”), the data mover program 212 executes S1107. If the file is migrated for the first time (S1107 “Yes”), the data mover program 212 migrates the file to the cloud storage 300 and simultaneously sends the file name (S1109). If the migration of the file is not the first time (S1107 “No”), the data mover program 212 migrates the file to the cloud storage 300 and further sends the ID acquired when the last migration was executed to another cloud storage 300 (S1110).

In S1109, the cloud storage 300 will identify the migrated file via the file name in the file storage 200. In S1110, the cloud storage 300 will identify the migrated file via the same identification information as the identification information in another cloud storage 300. Further, in both S1109 and S1110, similar to S1108, the program connects to the cloud storage by referring to the entry of the connection information table 216 corresponding to the migration destination cloud storage 300.

After executing S1108, S1109 and S1110, the data mover program 212 confirms whether the migration process has succeeded or not in S1111. If the migration process has succeeded (S1111 “Yes”), the data mover program 212 adds to the file information table 260 of the Stub information created in S1104 an entry having the name of the file migration destination cloud storage 300 entered to the CS name field 801. Further, the data mover program 212 stores the identification information acquired from the cloud storage or the set identification information or the file name to the file ID field 802, and stores “ACTIVE” in the CS access availability status field 803 (S1112).

On the other hand, if failure of the migration process is confirmed (S1111 “No”), the data mover program 212 executes S1113. In S1113, the data mover program 212 adds an entry having the name of the cloud storage 300 as the migration destination of the file stored in the CS name field 801 to the file correspondence information table 260 of the Stub information created in S1104. The data mover program 212 does not store any data in the file ID field 802 of the added entry, and stores “ERROR” indicating that migration has failed in the CS access availability status field 803.

If the cloud storage 300 could not be connected in S1108, S1109 and S1110, the data mover program 212 sets the CS status field 502 of the entry of the status information table 215 corresponding to the cloud storage 300 that could not be connected to “INACTIVE”. If connection has succeeded in S1108, S1109 and S1110, the data mover program 212 sets the CS status field 502 of the entry of the status information table 215 corresponding to the connected cloud storage 300 to “ACTIVE”.

Next, in S1114, the data mover program 212 confirms whether migration process of the file selected in S1102 to all cloud storages 300 matching the entry of the migration policy 214 acquired in S1101 has been performed or not. Then, if there is a cloud storage 300 to which migration has not been performed, the data mover program 212 executes the process of S1105, and if not, the program executes the process of S1115.

In S1115, the data mover program 212 confirms whether the migration process of all the files matching the entry of the migration policy 214 acquired in S1101 has been performed or not. If there is a file that has not been migrated, the data mover program 212 performs the process of S1102, and if not, the program performs the process of S1116. In S1116, the data mover program 212 confirms whether the migration process corresponding to all entries of the migration policy 214 has been performed or not, and if there is an entry that has not yet been performed, the process is performed once again from S1101, and if not, the process is ended.

By the aforementioned process, the files stored in the file storage 200 are migrated to one or more cloud storages 300 according to the migration policy 214. Thus, the backup data and the archive data of the file can be multiplexed. Further, since the cloud storage 300 to be set as the migration destination is selected based on the properties of the files and the properties of the cloud storages 300, it becomes possible to perform tier control using a plurality of cloud storages 300.

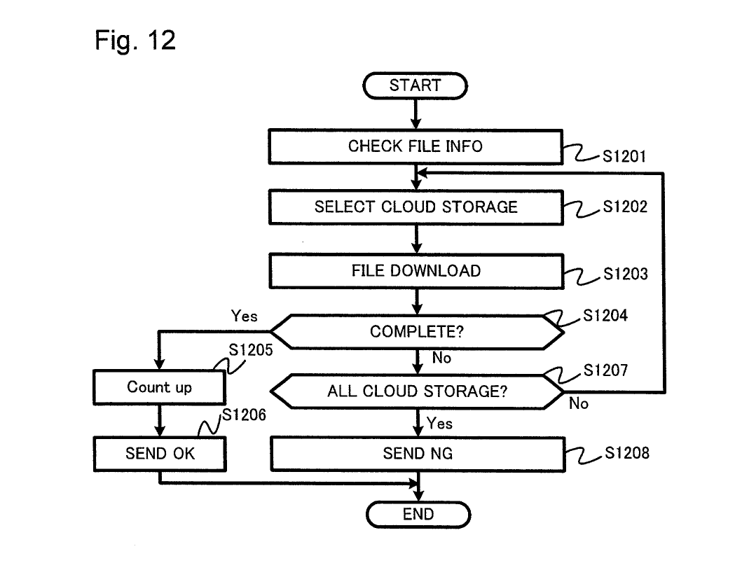

Next, with reference to FIG. 12, the process for downloading a migrated file in the cloud storage 300 to the file storage 200 will be explained. The download process is performed for providing a corresponding file to the client 100 when the client 100 accesses the Stub information 251.

FIG. 12 shows a process flow for the data mover program 212 to download a file from the cloud storage 300 to the file storage 200 based on the request from the NFS/CIFS server program 211. Upon receiving a request for downloading a file from the NFS/CIFS server program 211, the data mover program 212 confirms the file information table 260 of the designated Stub information 251 (S1201) and selects the cloud storage 300 to be set as the download source (S1202). At this time, the program refers to the status information table 215 and selects a cloud storage 300 having performed the least number of downloads.

Next, in S1203, the data mover program 212 downloads the file from the cloud storage 300 having been selected in S1202. At this time, the data mover program 212 refers to the entry of the connection information table 215 and connects to the download source cloud storage 300, so as to acquire the file of the identification information denoted in the file ID field 802 of the file information table 260.

Next, in S1204, the data mover program 212 determines whether the download process in S1203 has succeeded or not. If download was successful, the data mover program 212 increments the value of the download count field 503, in other words, the download count, of the status information table 215 of the download source cloud storage 300. Lastly, the data mover program 212 returns “OK” meaning that the download was successful to the NFS/CIFS server program 211 in S1206, and ends the process.

In S1204, when download has failed, the data mover program 212 confirms in S1207 whether the download process was performed in the cloud storages 300 of all entries stored in the file information table 260. If there is a cloud storage 300 that has not performed download, the data mover program 212 performs the download process from another cloud storage 300 in S1202.

As a result of S1207, if the download process has been performed from all cloud storages 300, the data mover program 212 returns “NG” meaning that download has failed to the NFS/CIFS server program 211 in S1208.

Thus, even if error occurs in the cloud storage 300 and download cannot be performed, download can be performed from another cloud storage 300, according to which a disaster recovery in an arrangement including a plurality of cloud storages 300 can be realized. Further, since the cloud storage 300 to be set as the source of download of the file is selected considering the number of times of download, the load of the download process can be dispersed among the cloud storages 300.

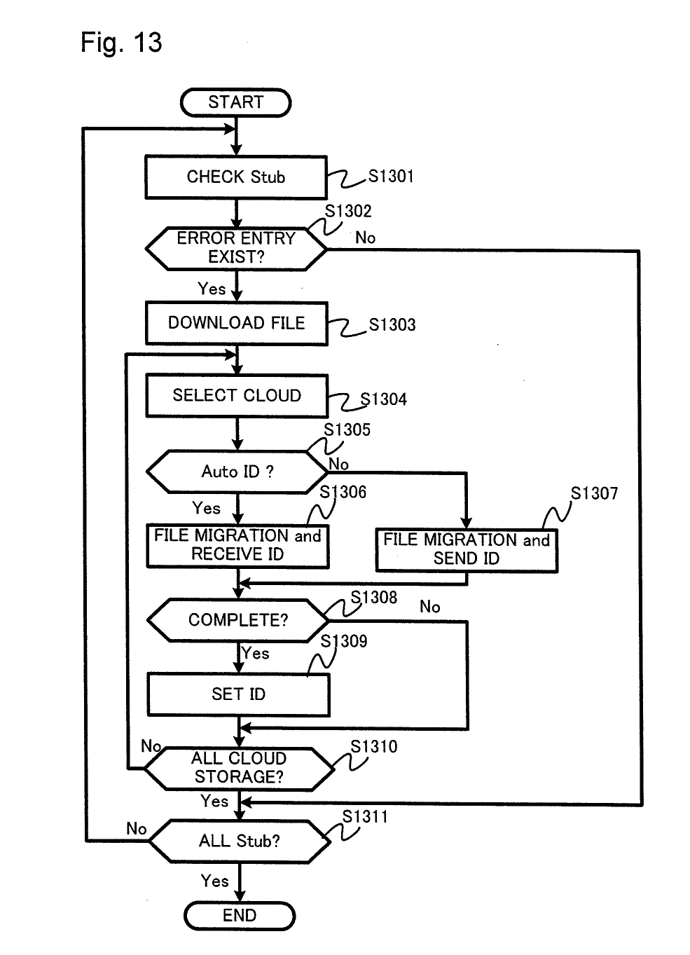

For example, if a portion of the migration destination cloud storages 300 has stopped due to failure or the like and the migration process therefrom has failed, it is necessary to perform migration again from the cloud storages 300 having failed migration at a later time. FIG. 13 shows a process flow of the data mover program 212 in such a case.

At first in S1301, the data mover program 212 acquires one Stub information 251, and in S1302, confirms whether an “ERROR” entry exists or not in the value of the CS access availability status field 803 of the file information table 260 included in the Stub information 251. If there is no “ERROR” entry in the value of the CS access availability status field 803 as a result of S1302, the data mover program 212 executes the process of S1311, and if such entry exists, the program executes the process of S1303.

In S1303, the data mover program 212 downloads a file from the cloud storage 300 having completed migration. Next, in S1304, the data mover program 212 selects a cloud storage 300 to be set as the migration destination of the file downloaded in S1303. Actually, the data mover program 212 selects one cloud storage 300 denoted in the CS name field 801 of the entry whose value of the CS access availability status field 803 of the file information table 260 in the Stub information acquired in S1301 is “ERROR”.

Next, the data mover program 212 refers to the setup ID field 602 of the entry of the connection information table 216 corresponding to the cloud storage 300 selected in S1304, and confirms whether the ID is set automatically or not (S1305). When it is confirmed that the ID is set automatically, the data mover program 212 migrates the file to the cloud storage 300 in S1306 and receives the identification information added via the cloud storage.

If as a result of confirming in S1305 the cloud storage does not perform automatic setup, the data mover program 212 migrates the file to the cloud storage 300 in S1307. At the same time, the data mover program 212 selects in the file information table 260 a file ID field 802 of an entry whose value of the CS access availability status field 803 is not “ERROR”, and notifies the cloud storage 300 to set the same as identification information.

In both S1306 and 1307, the data mover program 212 connects to the migration destination cloud storage 300 based on the information in the entry of the connection information table 216. Next, the data mover program 212 confirms whether the migration process according to S1306 and S1307 has been successful or not (S1308). If successful, the data mover program 212 stores the identification information acquired from the cloud storage or the setup identification information or the file name to the file ID field 802 of the entry of the file information table 260 selected in S1303, and stores “ACTIVE” in the CS access availability status field 803 (S1309).

Next, the data mover program 212 confirms in S1310 whether there is an entry of a cloud storage 300 not having performed migration within the entries in which “ERROR” is stored as the value of the CS access availability status field 803 included in the file information table 260. If there is an entry (S1310 “No”), the data mover program 212 executes S1304, and if there is no entry (S1310 “Yes”), the program executes S1311.

The data mover program 212 confirms in S1311 whether the process has been performed for all the Stub information within the file storage 200. If there is a Stub information that has not been subjected to the process (S1311 “Yes”), the data mover program 212 returns to S1301 and executes the sequence of processes again. If there is no Stub information that had not been subjected to the process (S1311 “No”), the data mover program 212 ends the process. According to this process, for example, a file that had not been migrated due to the failure of a cloud storage 300, for example, can be migrated when the storage recovers from the failure.

As described, according to the first embodiment of the present invention, the file storage 200 migrates the files stored in the file storage 200 to a plurality of cloud storages 300, and the identification information of files in the respective cloud storages 300 are managed via a single Stub information. Further, the forms of connection that differ among cloud storages 300 are managed in the connection information table 216, and based on the information stored therein, communication with cloud storages 300 are performed.

Furthermore, the migration destination cloud storages are selected according to the properties of the cloud storages 300. By applying the above arrangement and operation, a system using a plurality of cloud storages in heterogeneous environment enables to use files from other cloud storages 300 even if failure occurs in a cloud storage. Further, dispersion of load among cloud storages 300 and tier control thereof is enabled. As a result, the usability and operability of the system is enhanced.

### Embodiment 2

One of the arrangements in which the file storage utilizes a plurality of cloud storages is an arrangement where the cloud storage connected to the file storage utilizes another cloud storage, that is, an arrangement in which the cloud storages are cascaded. The second embodiment of the present invention assumes this cascaded arrangement.

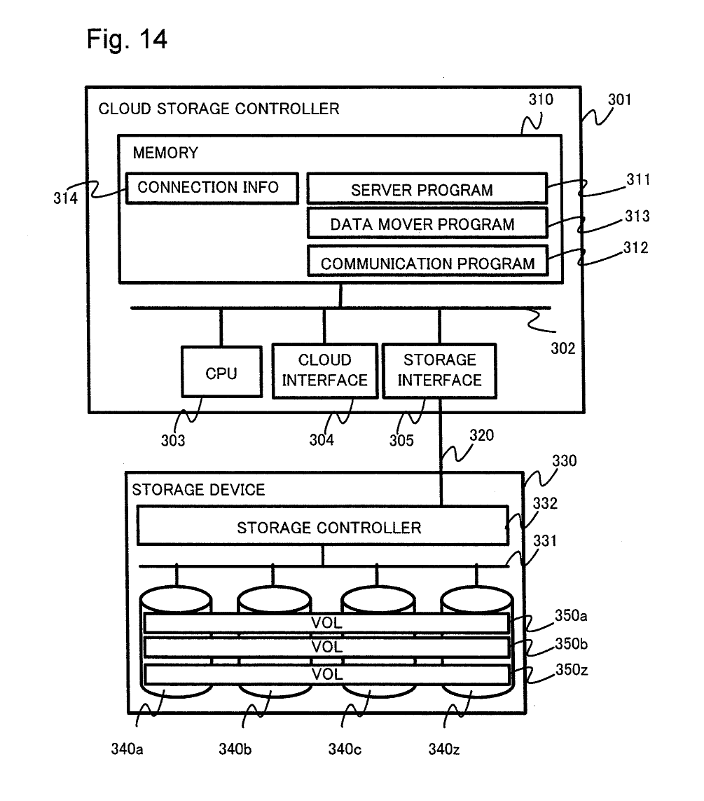

The second embodiment of the present invention will be described with reference to FIGS. 14 through 17. The explanation of contents that are the same as the first embodiment are omitted. FIG. 14 is a view showing one example of a cloud storage 300 according to the present embodiment. The difference from the cloud storage 300 of embodiment 1 is that in the present embodiment, the memory 310 stores a data mover program 313 and a connection information table 314 storing connection information with the cloud storage 300 connected in cascaded structure.

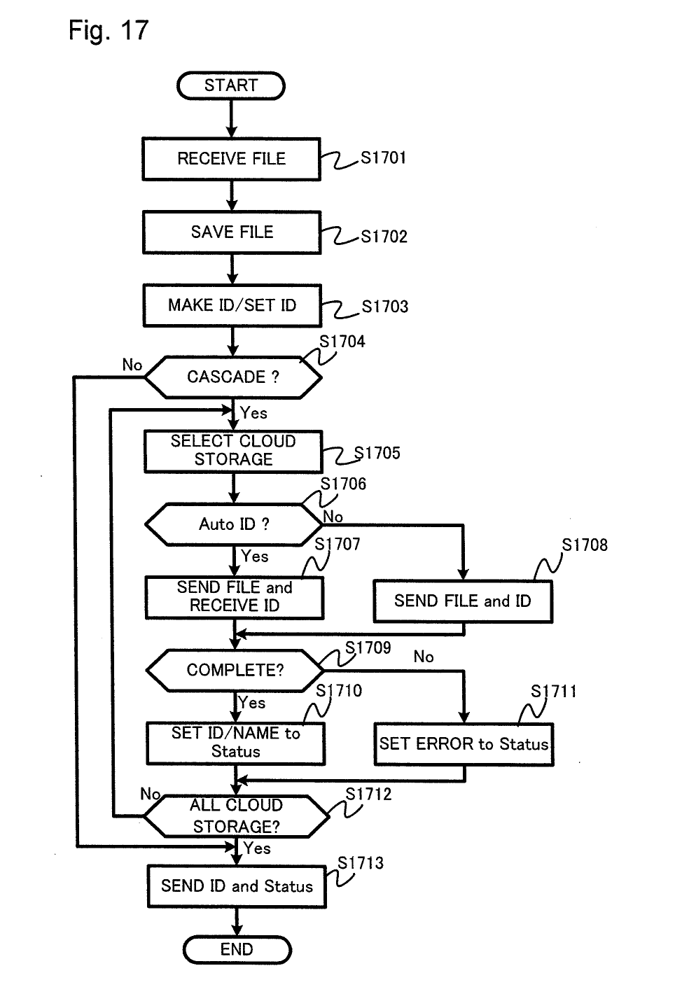

The arrangement of the connection information table 314 is the same as the connection information table 216 of the first embodiment, so detailed description thereof is omitted. However, the connection information table of the cloud storage 300 according to the present embodiment stores only the information related to the cloud storage 300 to which the present cloud storage 300 replicates files. The data mover program 313 differs from the data mover program 212 of the file storage 200 according to the first embodiment, so the process performed via the program will be described later with reference to FIG. 17.

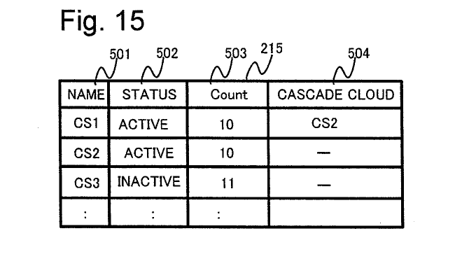

The arrangement of the file storage 200 of embodiment 1 is the same as the arrangement of the file storage 200 of embodiment 2, but the configuration of a status information table 215 storing the status of the cloud storage 300 differs. FIG. 15 illustrates one example of the status information table 215 according to the present embodiment. As shown in FIG. 15, the status information table 215 according to the present embodiment has a CS name field 501 for storing the name for identifying the cloud storage 300, a CS status field 502 storing the status of the cloud storage 300 denoted by the name in the CS name field 501, a download count field 503 for storing the number of downloads of files from the cloud storage 300 denoted by the name in the CS name field 501, and a replication target CS field 504 for storing the cloud storage 300 to which the files migrated from the file storage 200 are replicated from the cloud storage 300 denoted by the name in the CS name field 501.

For example, according to an entry whose value in the CS name field 501 is “CS1”, it can be recognized that the cloud storage “CS1” is active “ACTIVE”, that files have been downloaded ten times from the file storage 200, and that the files migrated from the file storage 200 are replicated to the cloud storage “CS2”.

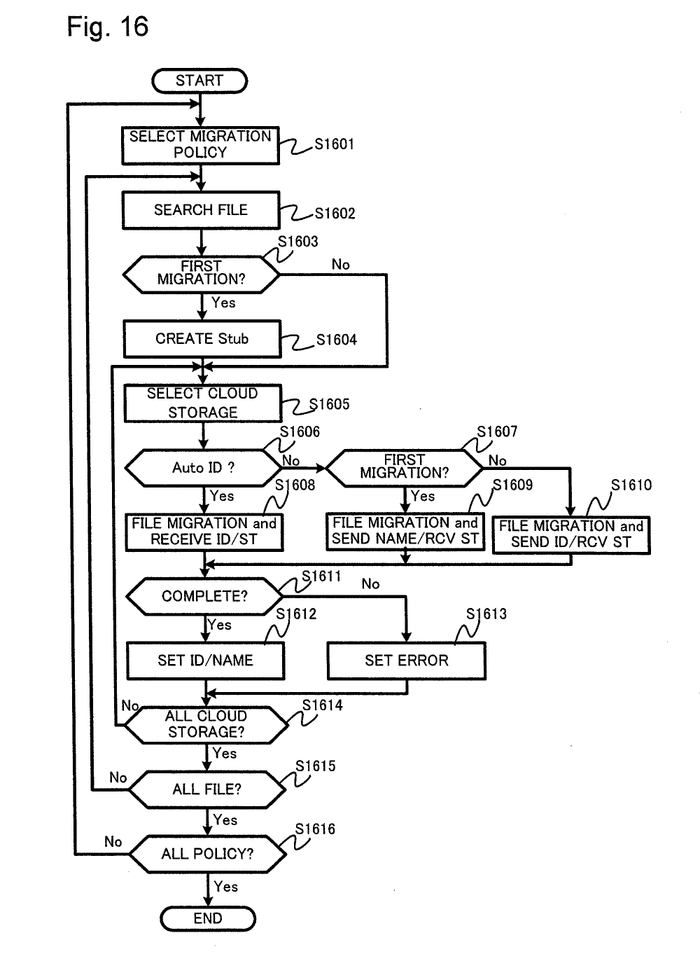

Next, the process for migrating files from the file storage to the cloud storage will be described with reference to FIG. 16. FIG. 16 is a flowchart of the process in which the data mover program 212 of the file storage 200 migrates the files in the file storage 200 to the cloud storage 300 according to the migration policy 214.

At first in S1601, the data mover program 212 acquires one entry of the migration policy 214. Next, in S1602, the data mover program 212 searches a file matching the conditions of the file policy field 402 of the migration policy 214 acquired in S1601 from the file sharing system. If the file searched in S1602 is migrated for the first time, the data mover program 212 creates a Stub information for that file in the file sharing system (S1603, S1604).

Next, in S1605, the data mover program 212 selects a cloud storage 300 matching the contents of conditions of the cloud storage (CS) policy field 403 of the migration policy 214 acquired in S1601 from the connection information table 216 or the property information table 217. At this time, the data mover program 212 selects a cloud storage 300 not having its name stored to the replication target CS field 504 of the respective entries of the status information table 215. In other words, the data mover program 212 does not select a file storage having files replicated from other cloud storages 300.

For example, if the entry whose value of the policy ID field 401 of the migration policy 214 is “P1” is selected in S1601, all the cloud storages 300 (ALL STORAGE) will be the target of selection, but the cloud storage “CS2” stored in the replication target CS field 504 of the first entry in the status information table 215 will not be the target of selection.

Next in S1606, the data mover program 212 refers to the setup ID field 602 of the entry in the connection information table 216 corresponding to the cloud storage 300 selected in S1605, and confirms whether the cloud storage 300 selected in S1605 automatically sets up an identification information of the stored files or not.

If the identification information is set up automatically, that is, if the value of the setup ID field 602 is “Auto”, the data mover program 212 migrates in S1608 the file selected in S1602 to the cloud storage 300 selected in S1605. Then, the data mover program 212 acquires the identification information of the file migrated from the cloud storage 300, the name for identifying the replication destination cloud storage 300 as a result of replicating the file from the cloud storage 300 to another cloud storage 300, and an identification information of the file in the replication destination file storage. At this time, the data mover program 212 refers to the entry of the connection information table 216 corresponding to the migration destination cloud storage 300, and sends the file thereto.

If the identification information is not set up automatically as a result of the confirmation in S1606, that is, if the value of the setup ID field 602 is “Free”, the data mover program 212 executes the process of S1607. If the migration is performed for the first time, the data mover program 212 migrates the file to the cloud storage 300 and sends the file name. Then, the data mover program 212 acquires the name for identifying the replication destination cloud storage 300 as a result of replicating the file in the cloud storage 300 to another cloud storage 300, and acquires an identification information of the file in the replication destination file storage (S1609).

If the migration is not the first time, the data mover program 212 migrates the file to the cloud storage 300 and sends the ID acquired when the migration was last performed to another cloud storage 300. The data mover program 212 acquires the name for identifying the replication destination cloud storage 300 as a result of replicating the file in the cloud storage 300 to another cloud storage 300, and acquires an identification information of the file in the replication destination file storage (S1610).

In S1609, the cloud storage 300 identifies the migrated file via the file name in the file storage 200. In S1610, the cloud storage 300 identifies the migrated file via the same identification information as the identification information in another cloud storage 300. Further, in both S1609 and S1610, similar to S1608, the data mover program 212 refers to the entry of the connection information table 216 corresponding to the migration destination cloud storage 300, and connects to the cloud storage.

After performing S1608, S1609 and S1610, the data mover program 212 confirms in S1611 whether the migration process has succeeded or not, and if succeeded, performs S1612. In S1612, the data mover program 212 adds an entry having the name of the cloud storage 300 to which the file has been migrated as the value of the CS name field 801 in the file correspondence information table 260 of the Stub information created in S1604. Further, the data mover program 212 stores the identification information acquired from the cloud storage 300 or the set identification information or the file name to the file ID field 802, and stores “ACTIVE” in the CS access availability status field 803. Furthermore, the data mover program 212 adds an entry to the file information table 260 and stores information in a similar manner upon acquiring the name of the replication destination cloud storage 300 from the migration destination cloud storage 300 and the identification information within that cloud storage 300.

If it is confirmed in S1611 that the migration process has failed, the data mover program 212 performs S1613. In S1613, the data mover program 212 adds an entry having the name of the cloud storage 300 to which the file has been migrated stored in the value of the CS name field 801 to the file correspondence information table 260 of the Stub information created in S1604. The data mover program 212 does not store any data in the file ID field 802 of the added entry, and stores “ERROR” indicating that migration has failed to the CS access availability status field 803.

Further, if the cloud storage 300 cannot be connected in S1608, S1609 and S1610, the data mover program 212 sets the CS status field 502 of the entry in the status information table 215 corresponding to the cloud storage 300 that could not be connected to “INACTIVE”. If connection succeeds in S1608, S1609 and S1610, the data mover program 212 sets the CS status field 502 of the entry of the status information table 215 corresponding to the connected cloud storage 300 to “ACTIVE”.

Next in S1614, the data mover program 212 confirms whether the migration process of the file selected in S1602 has been performed to all the cloud storages 300 matching the entries of the migration policy 214 acquired in S1601. If there is a cloud storage 300 that has not been subjected to migration, the data mover program 212 performs the process of S1605, and if not, the program performs the process of S1615.

The data mover program 212 confirms whether the migration process of all files matching the entries of the migration policy 214 acquired in S1601 has been performed or not in S1615. The data mover program 212 performs the process of S1602 when there is a file not being subjected to migration process, and if not, the program performs the process of S1616. The data mover program 212 confirms in S1616 whether the migration process has been performed according to all entries of the migration policy 214, wherein if there is an entry not having been subjected to the process, the process is performed once again from S1601, and if not, the process is ended.

According to the above process, the file stored in the file storage 200 can be migrated to one or more cloud storages 300 according to the migration policy 214. Thereby, backup data and the archive data of the file can be multiplexed. Furthermore, since the migration destination cloud storage 300 can be selected based on the properties of the files and the properties of the cloud storages 300, it becomes possible to perform tier control using a plurality of cloud storages 300 easily.

Next, the file migration process from a file storage will be described with reference to FIG. 17. FIG. 17 illustrates a flowchart of a process of the data mover program 313 of the cloud storage 300 migrating a file from the file storage 200. In S1701, the data mover program 313 receives the migrated file from the file storage 200, and stores the file in a storage area 350 of the cloud storage 300 in S1702.

Next in S1703, the data mover program 313 sets the identification information having created the identification information of the file stored in the storage area 350 or the identification information acquired from the file storage 200 as an identification information of the file stored in the storage area 350. Thereby, the saving of the file to the cloud storage 300 is completed.

Next in S1704, the data mover program 313 confirms whether an entry exists in the connection information table 314 or not. Thereby, it is confirmed whether a cloud storage 300 as the destination of replication of the saved file exists or not. As a result of S1704, if there is an entry in the connection information table 314, the data mover program 313 acquires one entry (S1705) and replicates the file to a cloud storage 300 denoted by the entry (S1706 to S1712). As a result of S1704, if there was no entry in the connection information table 314, the data mover program 313 performs S1713.

In S1706, the data mover program 313 refers to the setup ID field 602 of the entry in the connection information table 314 acquired in S1705, and confirms whether the cloud storage 300 denoted in the CS name field 601 of the entry selected in S1705 automatically sets up the identification information of the stored file or not. If the identification information is set automatically, in other words, if the value of the setup ID field 602 is “Auto”, the data mover program 313 replicates in S1707 the file received from the file storage 200 in S1701 to the cloud storage 300 denoted by the value in the CS name field 601 of the entry selected in S1705. Then, the data mover program 313 acquires the identification information of the file replicated from the replication destination cloud storage 300. At this time, the data mover program 313 refers to the entry of the connection information table 216 corresponding to the replication destination cloud storage 300, and connects to the cloud storage 300 to send the file.

If the identification information is not set up automatically as a result of the confirmation in S1706, that is, if the value of the setup ID field 602 is “Free”, the data mover program 313 replicates the file to the cloud storage 300 in S1708, and sends the identification information set up in S1702. After performing S1707 and S1708, the data mover program 313 confirms in S1709 whether the replication process has succeeded or not. If the replication process has succeeded, the data mover program 313 saves the name of the replication destination cloud storage 300 and the identification information of the file in the replication destination cloud storage 300 (S1710). If the replication process has failed as a result of S1709, the data mover program 313 saves the name of the replication destination cloud storage 300 and the information that the replication has failed (S1711).

Next in S1712, the data mover program 313 confirms whether the file has been replicated for all the entries of the connection information table 314. The data mover program 313 performs the process of S1705 if there is an entry that has not been subjected to replication, and performs the process of S1713 if there is no entry that has not been subjected to replication. In S1713, the data mover program 313 sends to the file storage 200 the identification information of the file set in S1703, the replication destination cloud storage 300 stored in S1710 and S1711, and the identification information of the file in the replication destination cloud storage 300 or the information that replication has failed, and ends the process.

As described, even in an arrangement in which a cloud storage connected to the file storage is connected via cascade connection to another cloud storage, the files stored in the file storage 200 can be migrated to a plurality of cloud storages 300. Further, the identification information of files in the respective cloud storages 300 can be managed via a single Stub information in the file storage 200. Furthermore, the file storage 200 manages the forms of connection that differ among cloud storages 300 in a connection information table, and communication with the cloud storage 300 is enabled based on the information.

Furthermore, the file storage 200 can select the migration destination cloud storage based on the properties of the cloud storage 300. Based on the above-described arrangement and operation, even if failure occurs to a cloud storage 300 in a system utilizing a plurality of cloud storages 300 in heterogeneous environment, the files in other cloud systems 300 can be used. Further, the load dispersion and tier control among cloud storages 300 becomes possible. As a result, the usability and operability of the system is enhanced.

### INDUSTRIAL APPLICABILITY

The present invention can be applied to storage devices such as storage systems, information processing apparatuses such as large-scale computers, servers and personal computers, and communication devices such as cellular phones and multifunctional mobile terminals.

### REFERENCE SIGNS LIST

1, 2 Network

100 File storage client

102, 203, 303 CPU

103 Network interface

110, 210, 310 Memory

101, 202, 231, 302, 331 Internal bus

111 NFS/CIFS client program

112, 213, 312 Communication program

200 File storage

201 File storage controller

204 Client interface

205, 304 Cloud interface

230, 330 Storage device

206, 305 Storage interface

211 NFS/CIFS server program

212, 313 Data mover program

300 File storage

214 Migration policy

215 Status information table

216, 314 Connection information table

217 Property information table

250a, 250b, 250z, 350a, 350b, 350z Logical volume

240a, 240b, 240c, 240z Hard disk

340a, 340b, 340c, 340z Hard disk

232 Storage

220, 320 Connecting line

232, 332 Storage controller

250 File sharing system

251 Stub information

260 File information table

300 Cloud storage

301 Cloud storage controller

311 Server program

332 Storage controller

350 Storage area

351a, 351b, 351c File

401 Policy ID field

402 File policy field

403 Cloud storage (CS) policy field

501, 601, 701, 801 CS name field

502 CS status field

503 Download count field

504 Replication target CS field

602 Setup ID field

603 IP address/DNS name field

604 Protocol field

605 Authentication information field

606 Encrypted communication system field

607 Key information field

608 Usage information field

702 Performance field

703 Reliability field

704 Installation location field

705 Unit cost field

802 File ID field

803 CS access availability status field

1. An information system coupled to a plurality of storage devices, the information system comprising:
a control unit, a memory unit and a storage device unit,
wherein the control unit creates a file sharing information for sharing a file at the time of a first data migration for migrating a file in the storage device unit to a first storage device, and maps the file sharing information to the file being subjected to data migration; and
after a second data migration for migrating the file in the storage device unit to a second storage device that differs from the first storage device, the control unit maps the file being subjected to data migration to the file sharing information.

2. The information system according to claim 1, wherein the information system sends the file name to the first storage device at the time of the first data migration and acquires a specific information of the first storage device, and sends the file name and the specific information of the first storage device to the second storage device at the time of the second data migration, so as to share the file via the file name and the specific information.

3. The information system according to claim 1, wherein the file sharing information is composed of (1) a storage name, (2) a file name and (3) an access availability information to the file of the storage device.

4. The information system according to claim 1, wherein a file to be subjected to data migration and a data migration destination are determined based on a data migration information of the information system.

5. The information system according to claim 4, wherein the data migration information is composed of (1) a policy ID, (2) a selection condition of the file to be subjected to data migration, and (3) a selection condition of the data migration destination storage device of the selected file.

6. The information system according to claim 1, wherein a file to be subjected to data migration and a data migration destination are determined based on a connection information table for connecting to the storage device.

7. The information system according to claim 6, wherein the connection information table includes one or more of the following information of the storage device: (1) an identification name, (2) a setup ID indicating whether the identification information of a stored file is set automatically or set from an exterior, (3) an IP address/DNS name, (4) a communication protocol, (5) a connection authentication information, (6) an encrypted communication system, (7) a key information of encryption, (8) a usage information indicating whether the storage device is a private storage device that can be used within a company operating the information system or a public storage device having no usage limitation.

8. The information system according to claim 1, wherein a file to be subjected to data migration and the data migration destination are determined based on a property information table storing the property of the storage device.

9. The information system according to claim 1, wherein the property information table includes one or more of the following information of the storage device: (1) an identification name, (2) a property information, (3) a reliability information, (4) an installation location information, and (5) a bit unit cost information for storing data.

10. The information system according to claim 1, wherein upon receiving a file download request to the storage device from a computer coupled to the information system, a file is downloaded from the storage device having the least number of downloads in the status information table.

11. The information system according to claim 10, wherein the status information table is composed of the following information of the storage device: (1) an identification name, (2) an access availability information, and (3) number of times of download.

12. The information system according to claim 1, wherein when data migration is not successful, data migration to the storage device is performed again.

13. The information system according to claim 12, wherein whether to perform data migration again is determined based on the (3) file access availability information of the file sharing information.

14. An information system coupled to a plurality of storage devices, the information system comprising:
a control unit, a memory unit and a storage device unit,
wherein the control unit creates a file sharing information for sharing a file at the time of a first data migration for migrating a file in the storage device unit to a first storage device, and maps the file sharing information to the file being subjected to data migration;
after a second data migration for migrating the file in the storage device unit to a second storage device that differs from the first storage device, the control unit maps the file being subjected to data migration to the file sharing information; and
the control unit copies the file subjected to data migration to a third storage device that differs from the first and second storage devices, and based on a connection information of the second storage device, maps the second storage device to the third storage device.

15. The information system according to claim 14, wherein the connection information of the second storage device is composed of the following information of the storage device connected via cascade connection with the second storage device and sharing a file therewith: (1) an identification name, (2) a performance information, (3) a reliability information, (4) an installation location information, and (5) a bit unit cost information for storing data.

16. The information system according to claim 14, wherein upon receiving a file download request to the storage device from a computer coupled to the information system, a file is downloaded from the storage device having the least number of downloads in the status information table.

17. The information system according to claim 16, wherein the status information table is composed of the following information of the storage device: (1) an identification name, (2) an access availability information, (3) number of times of download, and (4) copy destination storage device information.

18. A method for managing data in an information system coupled to a plurality of storage devices, the information system comprising:
a control unit, a memory unit and a storage device unit,
wherein the control unit creates a file sharing information for sharing the file at the time of a first data migration of a file in the storage device unit to a first storage device which is one of said plurality of storage devices, and maps the file sharing information to the file being subjected to data migration; and
after a second data migration for migrating the file in the storage device unit to a second storage device that differs from the first storage device, the control unit maps the file being subjected to data migration to the file sharing information.

19. A method for managing data in an information system according to claim 18, wherein the information system sends the file name to the first storage device at the time of the first data migration and acquires a specific information of the first storage device, and sends the file name and the specific information of the first storage device to the second storage device at the time of the second data migration, so as to share the file via the file name and the specific information.
